(19) United States
(12) Patent Application Publication
(10) Pub. No.: US 2024/0262367 A1
(43) Pub. Date: Aug. 8, 2024

(54) INFORMATION PROCESSING DEVICE

(71) Applicant: TOYOTA JIDOSHA KABUSHIKI KAISHA, Toyota-cho (JP)

(72) Inventor: Kaori YAMADA, Nagakute-shi (JP)

(73) Assignee: TOYOTA JIDOSHA KABUSHIKI KAISHA, Toyota-cho (JP)

(21) Appl. No.: 18/406,363

(22) Filed: Jan. 8, 2024

(30) Foreign Application Priority Data
Feb. 8, 2023 (JP) 2023-017792

(51) Int. Cl. B60W 40/08; G10L 15/22

(52) U.S. Cl. CPC B60W 40/08; G10L 15/22; B60W 2540/21; G10L 2015/223

(57) ABSTRACT

A control unit of an information processing device mounted on a vehicle stores definition information that associates the content of an utterance by a vehicle user that instructs a predetermined device in the vehicle to execute a predetermined function with a response to the utterance. Update information for updating is received from a predetermined server device by wireless communication. Then, the control unit of the information processing device updates the definition information based on the update information.

### CROSS-REFERENCE TO RELATED APPLICATION

This application claims priority to Japanese Patent Application No. 2023-017792 filed on Feb. 8, 2023, incorporated herein by reference in its entirety.

### BACKGROUND

### 1. Technical Field

The present disclosure relates to an information processing device.

### 2. Description of Related Art

Japanese Unexamined Patent Application Publication No. 2022-24614 (JP 2022-24614 A) discloses an information output system. In the information output system disclosed in JP 2022-24614 A, a user's utterance is acquired, and the content of the acquired user's utterance is recognized. In the information output system, a process of outputting a question to a user and outputting a response to the content of the user's utterance according to the question is executed. Then, in the information output system, the degree of user's affirmation is derived based on the content of the user's utterance according to the question, and guidance information to be output to the user is determined based on the derived degree of affirmation.

### SUMMARY

An object of the present disclosure is to easily change the content of dialogue between a user and an information processing device.

An information processing device according to the present disclosure is an information processing device installed in a vehicle, and includes a control unit that executes receiving, from a predetermined server device by wireless communication, update information for updating definition information for associating content of an utterance by a user in the vehicle, the utterance instructing a predetermined device in the vehicle to execute a predetermined function, with a reply to the utterance, and updating the definition information based on the update information.

The present disclosure makes it possible to easily change the content of dialogue between the user and the information processing device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an update system;

FIG. 2 is a block diagram schematically showing an example of a functional configuration of an in-vehicle device;

FIG. 3 is a diagram showing an example of a table configuration of device information;

FIG. 4 is a diagram showing an example of a table configuration of definition information;

FIG. 5 is a flowchart of processing executed by the control unit of the in-vehicle device; and

FIG. 6 is a sequence diagram showing the flow of information processing in the update system.

### DETAILED DESCRIPTION OF EMBODIMENTS

It is assumed that a vehicle user speaks to an information processing device to instruct a predetermined device in the vehicle to execute a predetermined function. At this time, the information processing device responds to the user's utterance, so that a dialogue takes place between the user and the information processing device. Here, there is a case where it is desired to change the content of the reply by the information processing device to the user's utterance.

Therefore, the control unit of the information processing device according to the present disclosure receives update information for updating definition information from a predetermined server device through wireless communication. Here, the definition information is information that associates the content of an utterance by the user that instructs a predetermined device to execute a predetermined function with a response to the utterance. The control unit of the information processing device updates the definition information based on the update information.

Thus, the information processing device receives update information from a predetermined server device through wireless communication. Therefore, the information processing device can acquire the update information more easily than when the update information is input to the information processing device without using wireless communication (for example, using physical media). As a result, it is possible to easily change the content of the dialogue between the user and the information processing device.

Hereinafter, an embodiment of the present disclosure will be described with reference to the drawings. Unless otherwise specified, dimensions, materials, shapes, relative arrangements, and the like of components described in the present embodiments are not intended to limit the technical scope of the present disclosure to those alone.

### Embodiment

### System Overview

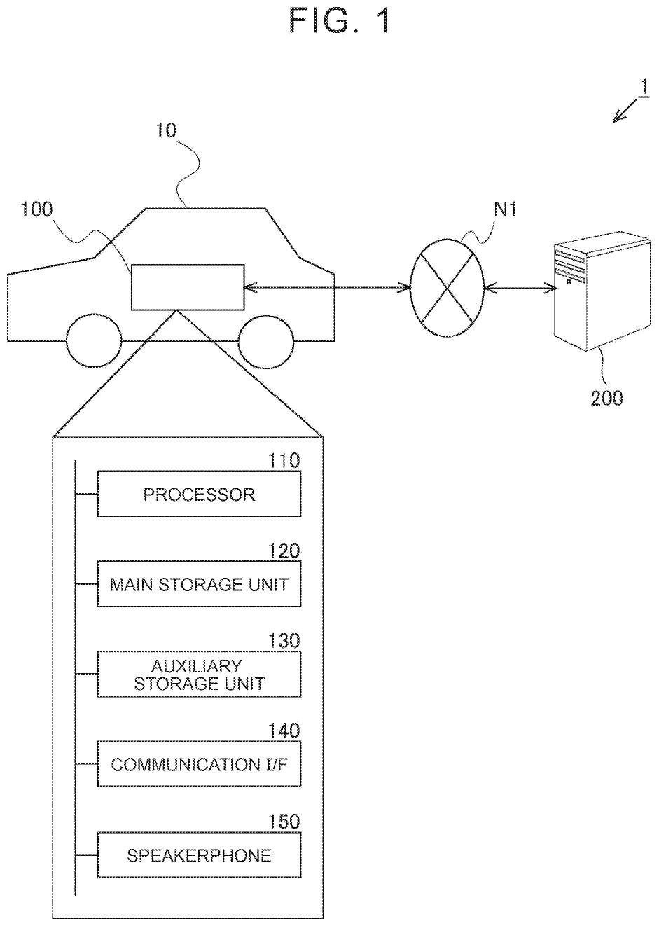

An update system 1 according to this embodiment will be described with reference to FIG. 1. FIG. 1 is a diagram showing a schematic configuration of an update system 1. The update system 1 includes an in-vehicle device 100 and a server 200. In the update system 1, the in-vehicle device 100 and the server 200 are interconnected by a network N1. The network N1 may employ, for example, a Wide Area Network (WAN), which is a worldwide public communication network such as the Internet, or a telephone communication network such as a mobile phone.

### In-Vehicle Device

The in-vehicle device 100 is a device mounted on the vehicle 10. The user makes an utterance to the in-vehicle device 100 to instruct the specific device mounted on the vehicle 10 to execute a specific function (hereinafter sometimes referred to as a “specific utterance”). Then, the in-vehicle device 100 responds to the specific utterance. As a reply to the specific utterance, the in-vehicle device 100 replies, for example, regarding execution of a specific function by the specific device. In this manner, the in-vehicle device 100 interacts with the user. The contents of the reply, for example, guide the user as to whether or not the specific function can be executed.

In this case, it may be necessary to change the content of the dialogue between the user and the in-vehicle device 100. Changing the content of the dialogue between the user and the in-vehicle device 100 includes, for example, changing the content of the reply to the specific utterance. Also, changing the contents of the dialogue between the user and the in-vehicle device 100 includes adding a new reply to the specific utterance. Also, changing the content of the dialogue between the user and the in-vehicle device 100 includes deleting at least part of the reply to the specific utterance.

The in-vehicle device 100 receives update information from the server 200 via the network N1 in order to change the contents of the dialogue between the user and the in-vehicle device 100. Here, the update information is information for updating definition information. Further, the definition information is information that associates the content of an utterance by the user instructing a predetermined device to execute a predetermined function with a response to the utterance. The in-vehicle device 100 interacts with the user based on the correspondence between the content of the utterance and the response in the definition information. Also, the predetermined device is a device mounted on the vehicle 10. Details of the definition information and the method by which the in-vehicle device 100 updates the definition information will be described later.

The in-vehicle device 100 includes a computer having a processor 110, a main storage unit 120, an auxiliary storage unit 130, a communication interface (communication UF) 140 and a speakerphone 150. Processor 110 is, for example, a Central Processing Unit (CPU) or a Digital Signal Processor (DSP). The main storage unit 120 is, for example, Random Access Memory (RAM). The auxiliary storage unit 130 is, for example, Read Only Memory (ROM). The auxiliary storage unit 130 is, for example, a hard disk drive (HDD), or a disk recording medium such as a CD-ROM, a DVD disk, or a Blu-ray disk. Further, the auxiliary storage unit 130 may be a removable medium (portable storage medium). Examples of the removable medium include a USB memory or an SD card. Communication I/F 140 is, for example, a Local Area Network (LAN) interface board or a wireless communication circuit for wireless communication. Speakerphone 150 is a device that includes a microphone and a speaker. Speakerphone 150 captures speech by a user and outputs audio to the user.

In the in-vehicle device 100, the auxiliary storage unit 130 stores an operating system (OS), various programs, various information tables, and the like. Also, in the in-vehicle device 100, the processor 110 loads the program stored in the auxiliary storage unit 130 into the main storage unit 120 and executes it, thereby realizing various functions as described later. However, some or all of the functions of the in-vehicle device 100 may be realized by hardware circuits such as ASICs or FPGAs. Note that the in-vehicle device 100 does not necessarily have to be realized by a single physical configuration, and may be configured by a plurality of computers that cooperate with each other.

### Server

The server 200 is a server that distributes update information. The server 200 includes a computer like the in-vehicle device 100. The server 200 receives information (hereinafter sometimes referred to as “confirmation information”) for confirming whether the definition information held by the in-vehicle device 100 needs to be updated from the in-vehicle device 100 via the network Ni. The confirmation information includes, for example, information indicating the version of definition information held by the in-vehicle device 100.

The server 200 transmits update information via the network N1 when the version of the definition information held by the in-vehicle device 100 is not the latest version. Thereby, the in-vehicle device 100 can update the definition information to the latest version. Here, the update information is, for example, difference data between the definition information of the old version and the definition information of the latest version. Also, the update information may be the latest version of the definition information itself. In this case, the in-vehicle device 100 rewrites the retained definition information of the old version with the definition information of the latest version received.

### Functional Configuration

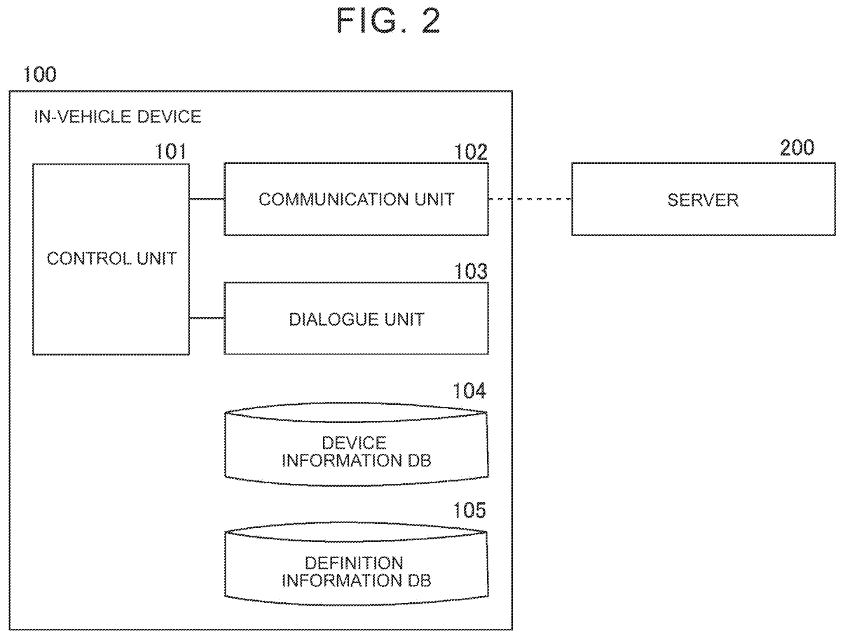

Next, the functional configuration of the in-vehicle device 100 that configures the update system 1 will be described with reference to FIGS. 2 to 4. FIG. 2 is a block diagram schematically showing an example of the functional configuration of the in-vehicle device 100. The in-vehicle device 100 includes a control unit 101, a communication unit 102, a dialogue unit 103, a device information database 104 (device information DB 104), and a definition information database 105 (definition information DB 105).

The control unit 101 has a function of performing arithmetic processing for controlling the in-vehicle device 100. The control unit 101 can be implemented by the processor 110 in the in-vehicle device 100. The communication unit 102 has a function of connecting the in-vehicle device 100 to the network N1. Communication unit 102 can be realized by communication OF 140 in in-vehicle device 100. The dialogue unit 103 has a function of acquiring an utterance by the user and outputting voice to the user. Dialogue unit 103 can be realized by speakerphone 150 of in-vehicle device 100.

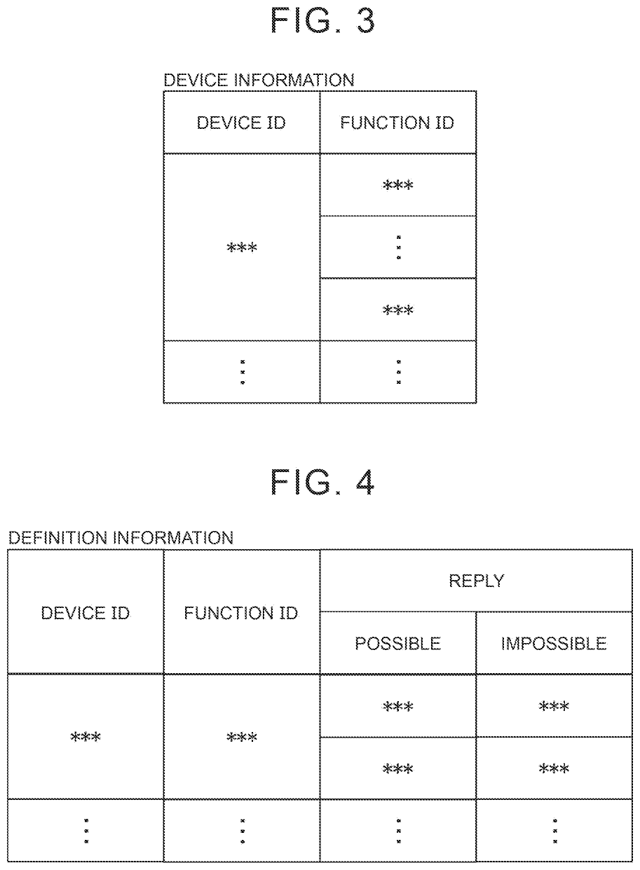

The device information DB 104 has a function of holding device information. The device information DB 104 can be implemented by the auxiliary storage unit 130 in the in-vehicle device 100. Here, the device information is information indicating the devices mounted on the vehicle 10 and the functions that the devices can execute. FIG. 3 is a diagram showing an example of a table configuration of device information. As shown in FIG. 3, the device information has a device ID field and a function ID field.

The device ID field stores an identifier (device ID) for specifying a device mounted on the vehicle 10. The device ID field stores device IDs of, for example, a car navigation system, an air conditioner, an electronic control unit (ECU), or the like mounted on the vehicle 10. The function ID field stores an identifier (function ID) for specifying a function executable by the device corresponding to the device ID stored in the device ID field.

The definition information DB 105 has a function of holding definition information. The definition information DB 105 can be implemented by the auxiliary storage unit 130 in the in-vehicle device 100. FIG. 4 is a diagram showing an example of a table configuration of definition information. As shown in FIG. 4, the definition information has a device ID field, a function ID field, and a reply field.

A device ID is entered in the device ID field. The function ID field stores the function ID of the function executed by the device indicated by the device ID stored in the device ID field.

The reply field stores information indicating the content of the reply to the specific utterance (hereinafter sometimes referred to as “response information”). The reply field stores reply information when the device indicated by the device ID stored in the device ID field can execute the function indicated by the function ID stored in the function ID field. The reply field stores reply information when the device indicated by the device ID stored in the device ID field cannot execute the function indicated by the function ID stored in the function ID field. Also, the response field may store different response information for each function of each device. Also, the reply information stored in the reply field may be information containing the contents of a plurality of patterns of reply. In this case, the control unit 101 selects the content of the reply from the plurality of patterns of reply content included in the reply information.

In the present embodiment, the definition information common between the in-vehicle device 100 and the in-vehicle device 100 other than the in-vehicle device 100 installed in the vehicle 10 (the in-vehicle device 100 installed in the vehicle other than the in-vehicle device 100) is used. Here, the vehicle 10 and other vehicles may not be equipped with the same device. Therefore, in the definition information, the device ID of a device that is not mounted on the vehicle 10 may be stored in the device ID field. Further, even if the vehicle 10 and other vehicles are equipped with the same device, there are cases where the configuration of functions that can be executed by the device is different. As a case where the configurations of executable functions are different even if the same device is installed, for example, a case where the execution of the functions is restricted is assumed. Therefore, in the definition information, the function ID of a function that cannot be executed by the device indicated by the device ID stored in the device ID field may be stored in the function ID field. Further, the device information may be information that differs from vehicle to vehicle.

As described above, the function indicated by the function ID may not be executable in the vehicle 10 because the device indicated by the device ID corresponding to the function ID in the definition information is not installed in the vehicle 10. Further, the function indicated by the function ID may not be executable in the vehicle 10 because the device indicated by the device ID in the definition information does not have a configuration capable of executing the function indicated by the function ID. Therefore, in the definition information, regardless of whether each device mounted on the vehicle 10 can actually execute each function, in two cases of whether each device can execute each function, reply information is stored.

The control unit 101 acquires a specific utterance by the user via the dialogue unit 103. The control unit 101 identifies the specific device and the specific function based on the acquired specific utterance. Control unit 101 identifies whether a specific device in vehicle 10 can execute a specific function based on device information held in device information DB 104. Specifically, based on whether or not a device ID indicating a specific device and a function ID indicating a specific function are stored in the device ID field and the function ID field in the device information DB 104, the control unit 101 determines whether a device is capable of performing a particular function. The control unit 101 generates specific information indicating whether the specific device can execute the specific function.

The control unit 101 acquires reply information for replying to the specific utterance from the definition information held in the definition information DB 105. Specifically, the control unit 101 acquires a device ID indicating a specific device, a function ID indicating a specific function, and specific information. Based on the device ID indicating the specific device, the function ID indicating the specific function, and the specific information, the control unit 101 acquires the reply information stored in the reply field.

The control unit 101 outputs a response to the specific utterance to the user by outputting voice via the dialogue unit 103 based on the acquired response information. Here, in the reply field of the definition information held in the definition information DB 105, different reply information is stored depending on whether the specific function can be executed by the specific device in the vehicle 10 or not.

Therefore, when the specific device can execute the specific function in the vehicle 10, for example, reply information for replying that the execution of the specific function is to be started is stored. Further, when the specific device cannot execute the specific function in the vehicle 10, reply information for replying to the effect that the specific function cannot be executed, for example, is stored. In this way, the control unit 101 makes different responses depending on whether the specific function can be executed by the specific device in the vehicle 10 or not.

Based on the specific information, the control unit 101 determines whether the specific function can be executed by the specific device. When the control unit 101 determines that the specific function can be executed by the specific device, the control unit 101 outputs execution information. Execution information is information for causing a specific device to execute a specific function. The control unit 101 transmits execution information to the specific device via the in-vehicle network of the vehicle 10. In this way, the control unit 101 causes the specific device to perform the specific function.

The control unit 101 updates definition information. Specifically, control unit 101 transmits confirmation information to server 200 via communication unit 102. For example, the control unit 101 transmits confirmation information to the server 200 when the in-vehicle device 100 is activated. Also, the control unit 101 may transmit confirmation information to the server 200 at a predetermined timing, for example. The predetermined timing is, for example, the timing when a predetermined cycle has arrived, the timing when the user performs an operation to update the definition information, or the like.

Control unit 101 receives update information from server 200 via communication unit 102. Here, the server 200 transmits update information to the in-vehicle device 100 when the version of the definition information held in the definition information DB 105 is not the latest version. The control unit 101 updates the definition information based on the received update information.

### Flowchart

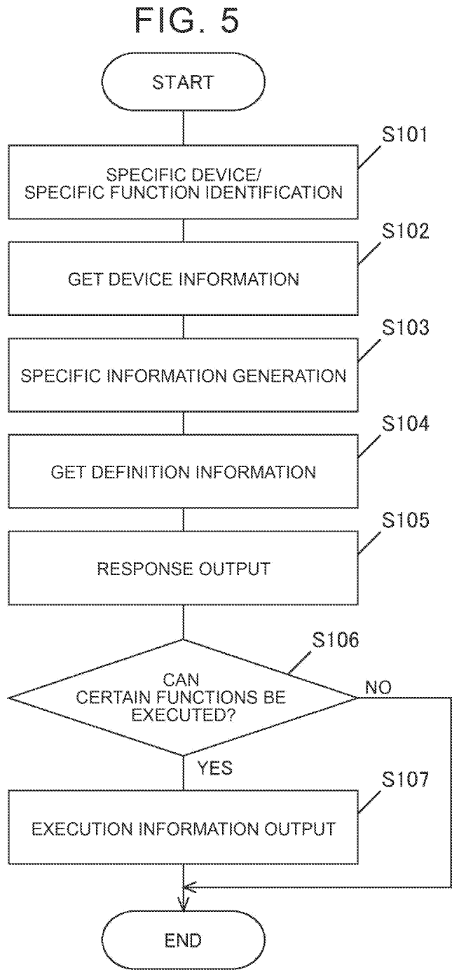

Next, processing executed by the control unit 101 in the in-vehicle device 100 in the update system 1 will be described with reference to FIG. 5. FIG. 5 is a flowchart of processing executed by the control unit 101. This processing is processing for outputting a reply to a specific utterance. The processing shown in FIG. 5 is started when the user makes a specific utterance.

In the process shown in FIG. 5, in S101, a specific device and a specific function are specified based on the specific utterance. Next, in S102, device information is acquired from the device information DB 104. Further, in S103, specific information is generated based on the device information. Next, definition information is obtained from the definition information DB 105 in S104. Then, in S105, reply information is acquired based on the specific information and the definition information, and a reply to the specific utterance is output based on the reply information. As a result, the in-vehicle device 100 can reply to the user via the dialogue unit 103 according to whether the specific function can be executed by the specific device in the vehicle 10.

Next, in S106, it is determined whether the specific device can execute the specific function based on the specific information. If an affirmative determination is made in S106, execution information is output in S107. Thereby, the specific function is executed by the specific device. Then, the processing shown in FIG. 5 ends. Further, when a negative determination is made in S106, execution of the specific function by the specific device is not possible. Therefore, the execution information is not output, and the processing shown in FIG. 5 is terminated.

### Flow of Information Processing

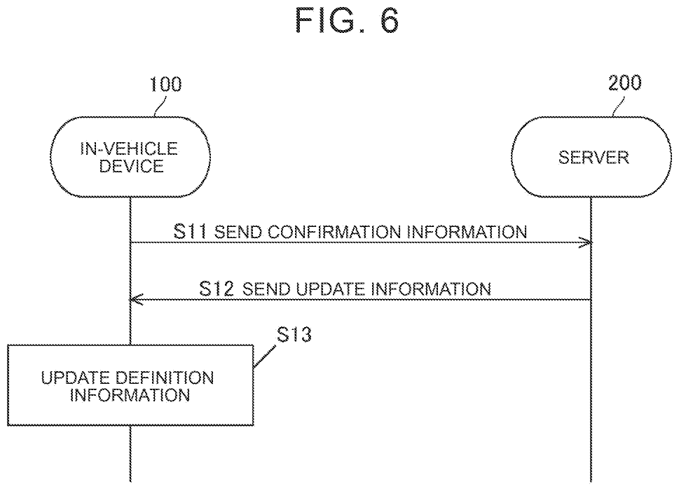

Next, the flow of information processing in the update system 1 will be described with reference to FIG. 6. FIG. 6 is a sequence diagram showing the flow of information processing in the update system 1 FIG. 6 shows the flow of information processing when the version of definition information in the definition information DB 105 is not the latest version. Each process executed by the in-vehicle device 100 and the server 200 is executed by the control unit 101 and the control unit in the server 200, respectively.

In the update system 1, the in-vehicle device 100 transmits confirmation information to the server 200 via the network N1 (S11). In the sequence diagram shown in FIG. 6, the version of the definition information held by the in-vehicle device 100 is not the latest version, so the server 200 transmits update information to the in-vehicle device 100 via the network N1 (S12). The in-vehicle device 100 updates the definition information based on the update information received from the server 200 (S13). Note that if the version of the definition information held by the in-vehicle device 100 is the latest version, the server 200 does not transmit the update information and sends information indicating that the definition information does not need to be updated to the in-vehicle device 100.

As described above, in the update system 1, the in-vehicle device 100 updates the definition information with the update information, so that the content of the dialogue between the user and the in-vehicle device 100 can be changed.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk (such as a magnetic disk (a floppy disk an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device installed in a vehicle, the information processing device comprising a control unit that executes
receiving, from a predetermined server device by wireless communication, update information for updating definition information for associating content of an utterance by a user in the vehicle, the utterance instructing a predetermined device in the vehicle to execute a predetermined function, with a reply to the utterance, and
updating the definition information based on the update information.

2. The information processing device according to claim 1, wherein the definition information includes
association between the content of the utterance and a response to the utterance when the predetermined device is able to execute the predetermined function, and
association between the content of the utterance and a response to the utterance when the predetermined device is not able to execute the predetermined function.

3. The information processing device according to claim 2, wherein the control unit further executes
acquiring a specific utterance by the user, the specific utterance instructing a specific device in the vehicle to execute a specific function, and
outputting a response to the specific utterance based on the definition information and whether the specific device is able to execute the specific function.

4. The information processing device according to claim 3, wherein the control unit identifies whether the specific device is able to execute the specific function based on whether the specific device is installed in the vehicle.

5. The information processing device according to claim 3, wherein the control unit identifies whether the specific device is able to execute the specific function based on whether the specific device is configured to be able to execute the specific function.
